(19) United States
(12) Patent Application Publication
(10) Pub. No.: US 2017/0352246 A1
(43) Pub. Date: Dec. 7, 2017

(54) EQUIPMENT MONITORING SYSTEM AND METHOD OF ITS USE

(71) Applicant: SITREP Marine Inc., Cheshire, CT (US)

(72) Inventors: Gary Martin, Hamden, CT (US); Harland Christofferson, Guilford, CT (US)

(73) Assignee: SITREP Marine Inc., Cheshire, CT (US)

(21) Appl. No.: 15/615,154

(22) Filed: Jun. 6, 2017

Related U.S. Application Data
(60) Provisional application No. 62/346,054, filed on Jun. 6, 2016.

(51) Int. Cl. G08B 21/18; G07C 3/14; G01D 9/00

(52) U.S. Cl. CPC G08B 21/182; G08B 21/18; G01D 9/005; G07C 3/14

(57) ABSTRACT

Methods and systems of the present disclosure are directed to monitoring an equipment apparatus and alerting an individual of a malfunction. The system is integrated with a target equipment apparatus to monitor operating conditions. When a baseline operating condition changes to an alarm condition, an alarm signal is sent to a monitor. The system also includes an external power supply so that the alarm signal can still be sent in the event of a power failure. The monitor sends a message output to a communication control module that includes a radio transmitter, such as a cellular radio transmitter or a satellite radio transmitter. The radio transmitter transmits a message to a receiver, such as a cellular phone or a satellite phone. The messages are sent repeatedly until the baseline operating condition is restored. The system can thus be used in methods to provide fast, reliable, and inexpensive remote monitor equipment apparatus such as heating systems, control systems, power systems, electrical systems, mechanical systems, and the like.

### CROSS REFERENCE TO RELATED APPLICATION(S)

This application claims the benefit of U.S. Provisional Application No. 62/346,054, filed Jun. 6, 2016, which is incorporated by reference as if disclosed herein in its entirety.

### BACKGROUND

In a review of property insurance claims from multiple insurance companies around the country resulting from plumbing supply system failures performed in 2012 by the Insurance Institute for Business and Home Safety, it was revealed that 48% of financial insurance payouts for water damage are due to plumbing system failures. Further, plumbing system failures were found to cost an average of $5,092 per incident after deductible and frozen pipe-related failures result in monetary losses roughly twice as severe as those caused by plumbing material failures.

Mitigating frozen pipe-related failures requires consistent furnace/boiler operation in sub-freezing temperatures when the building is unoccupied. If the furnace/boiler does fail in sub-freezing temperatures, a timely response by qualified personnel is required to mitigate water and property loss. However, in unoccupied buildings and spaces, monitoring may not be sufficiently frequent to provide a response timely enough to prevent the extensive damage a failure can cause.

Systems have been developed that are capable of remotely alerting an individual of a malfunctioning heating system. However, these systems rely on ambient temperature monitoring, and/or on often expensive internet connections or existing landline telephone systems.

### SUMMARY

In some embodiments, the present disclosure is directed to an equipment apparatus monitoring system that includes a control module for issuing an alarm signal in response to an event of the equipment apparatus going into an alarm condition, such as a malfunction or power loss. In some embodiments, the system of the present disclosure monitors any “dry contact,” i.e., electric continuity circuit, or voltage driven alarm output from existing equipment. In some embodiments, the equipment apparatus monitoring system sends a pre-programmed alarm message to at least one receiver, such as a cell phone, and/or a monitoring service, via a radio transmitter such as a cellular radio transmitter or a satellite radio transmitter.

The monitoring system of the present disclosure monitors building devices for alarm conditions, such as failure or power loss. If a heating system, or other critical appliance, should enter an alarm condition, the monitoring system will immediately send out a message to predesignated individuals or phones. In some embodiments, a copy can also be logged into the permanent data records of a monitoring service. In some embodiments, an “all clear” is sent when a baseline condition is restored, e.g., power is restored. In some embodiments, the “all clear” message is also provided to a monitoring service. In some embodiments, the monitoring system includes a battery backup in the event of a power failure.

In some embodiments, the monitoring system resembles a cellular phone network and may thus be priced accordingly. In some embodiments, no phone line or internet connection is employed.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1A is a schematic drawing of an equipment apparatus monitoring system according to some embodiments of the present disclosure;

FIG. 1B is a schematic drawing of an equipment apparatus monitoring system according to some embodiments of the present disclosure;

FIG. 1C is a schematic drawing of an equipment apparatus monitoring system according to some embodiments of the present disclosure;

FIG. 2A is a chart of a method of monitoring an equipment apparatus according to some embodiments of the present disclosure;

FIG. 2B is a chart of a method of monitoring an equipment apparatus according to some embodiments of the present disclosure;

FIG. 2C is a chart of a method of monitoring an equipment apparatus according to some embodiments of the present disclosure; and

FIG. 3 is a chart of a method of monitoring an equipment apparatus according to some embodiments of the present disclosure.

### DESCRIPTION

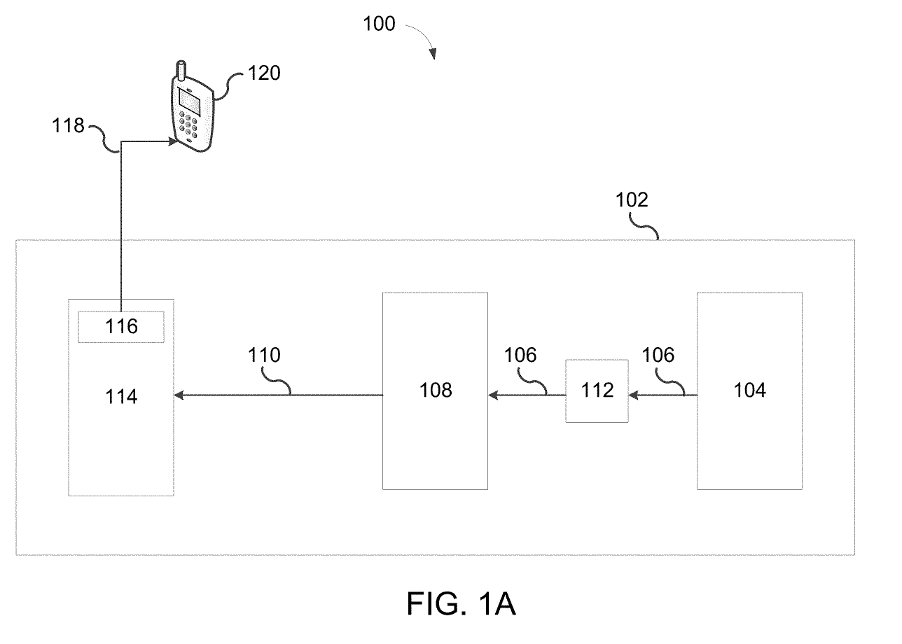

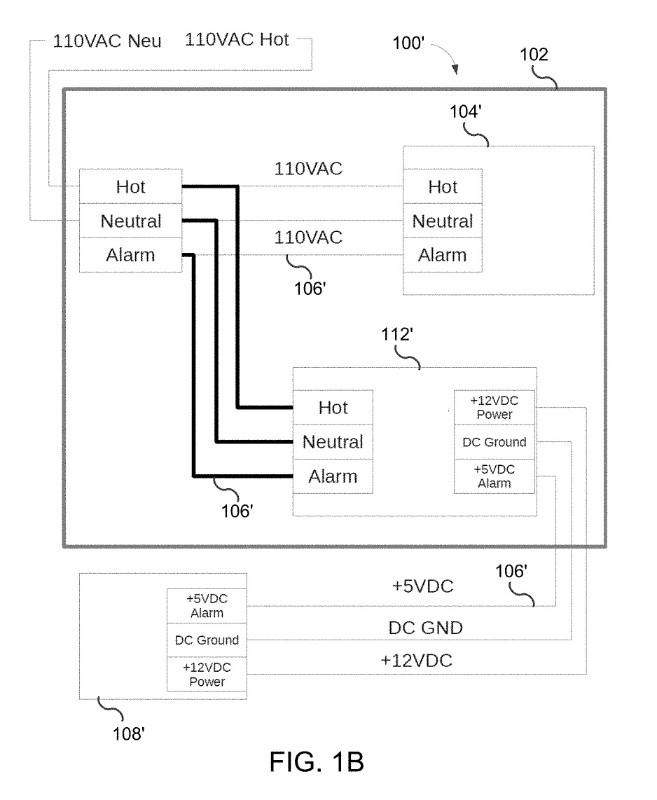

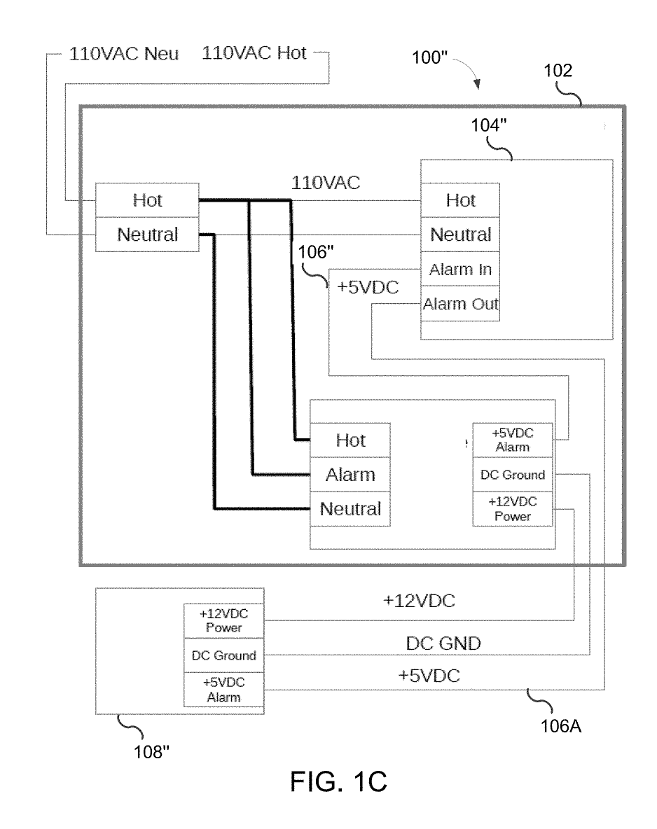

Referring now to FIG. 1A, aspects of the disclosed subject matter include a system 100 for monitoring an equipment apparatus 102. In some embodiments, system 100 includes a control module 104 integrated with the equipment apparatus 102. When discussed herein, a heating system is used as an exemplary embodiment of equipment apparatus 102, however, system 100 may be used to monitor systems and equipment other than heating systems as well. For example, in some embodiments, equipment apparatus 102 is a furnace or a boiler, a humidity control system, a sump water level control system, a power system, a mechanical system, and the like, or a combination thereof In some embodiments, system 100 monitors a plurality of equipment apparatus 102, as will be discussed in greater detail below.

Control module 104 is positioned in equipment apparatus 102 to detect an operating change in the equipment apparatus between a normal/baseline condition and a malfunction/alarm condition. In some embodiments, the alarm condition is the result of mechanical, electrical, or other malfunction with equipment apparatus 102. In some embodiments, the alarm condition is the result of mechanical, electrical, or other failure of system 100 itself In some embodiments, the alarm condition is a mechanical, electrical, or other failure in the space in which equipment apparatus 102 is installed. The “normal” or “baseline” condition refers to the routine parameters at which equipment apparatus 102 operates, as well as a tolerable deviation therefrom. The “malfunction,” “failure,” or “alarm” condition refers to a deviation from those routine parameters that either indicates that equipment apparatus 102 is not functioning properly or not functioning at all. Some exemplary operating changes of equipment apparatus 102 that can be monitored by system 100 include an environmental power failure, e.g., power supplied to the equipment apparatus' location is cut; equipment apparatus power failure, e.g., power supplied to the equipment apparatus is mistakenly cut during routine maintenance of another system; control module 104 power failure; an ignition failure, e.g., failure of a heating system to ignite a fuel provided to it; equipment apparatus component malfunction; and fuel depletion, e.g., a heating system is otherwise working properly, but does not receive fuel upon request from a fuel source. In some embodiments, the operating changes detected by system 100 and/or its components, and the manner in which those operating changes are detected, are designed by one having ordinary skill in the art to identify alarm operating conditions deemed disadvantageous for a specific equipment apparatus 102 or specific application of that equipment apparatus.

An alarm signal 106 is produced by control module 104 in response to the operating change from a baseline condition to an alarm condition. In some embodiments, alarm signal 106 is an alarm voltage output. In some embodiments, alarm signal 106 is AC line voltage. A monitor 108 is positioned to receive alarm signal 106 from control module 104.

Monitor 108 is also configured to produce and/or send a message output 110 in response to alarm signal 106. In some embodiments, message output 110 is a message voltage output. In some embodiments, a plurality of monitors 108 are provided, creating a network of monitored equipment apparatus 102. For example, an apartment building having separate water heaters for each unit installs separate monitors 108 in each water heater. When an individual water heater malfunctions, the monitor 108 for that water heater then produces message output 110 to indicate the malfunction of that water heater alone. Additionally, should all water heaters on an east side of a building malfunction, monitors 108 for those east water heaters would produce message outputs 110, which might indicate a system issue affecting the east side of the building, potentially making the cause of the malfunction faster and easier to fix.

In some embodiments, monitor 108 includes an external power supply 112. In some embodiments, external power supply 112 is a battery, a generator, a fuel cell, and the like or a combination thereof In some embodiments, alarm signal 106 received by monitor 108 has a lower voltage than the alarm signal sent by control module 104. In some embodiments, external power supply 112 is positioned to convert a higher voltage alarm signal 106 to a lower voltage, as well as supply power to monitor 108. In some embodiments, a separate voltage conversion module (not pictured) is provided to convert a higher voltage alarm signal 106 to a lower voltage. In some embodiments, monitor 108 is configured to convert a higher voltage alarm signal 106 to a lower voltage. In some embodiments, alarm signal 106 has a voltage above at least about 110V to about 120V. In some embodiments, a higher voltage alarm signal 106 is converted to a voltage below about 10V. In some embodiments, a higher voltage alarm signal 106 is converted to a voltage below about 5V. In some embodiments, alarm signal 106 received by monitor 108 has a voltage below about 10V. In some embodiments, alarm signal 106 received by monitor 108 has a voltage below about 5V.

Various wiring schemes for detecting an operating change, generating alarm signal 106, and sending message output 110 are suitable for use in system 100. Referring now to FIG. 1B, in some embodiments, upon detection of an operating change by control module 104′ in system 100′, an alarm voltage output 106′ is generated and sent to monitor 108′. In the embodiment shown in FIG. 1B, alarm voltage output 106′ is first generated at a different voltage and then converted to a lower voltage by power supply 112′. Referring now to FIG. 1C, in some embodiments, system 100″ is configured to maintain a substantially constant alarm signal voltage 106″, which is supplied to control module 104″. In these embodiments, an operation change to an alarm condition results in the completion of a circuit, sending the low voltage alarm voltage output 106A to monitor 108″.

Referring again to FIG. 1A, a communication control module 114 is positioned to receive message output 110. In some embodiments, communication control module 114 includes at least one radio transmitter 116. In some embodiments, radio transmitter 116 is a cellular radio transmitter or a satellite radio transmitter. In some embodiments, radio transmitter 116 is a GSM radio or a CDMA radio. In some embodiments, communication control module 114 and radio transmitter 116 are separate components in communication with each other. Communication control module 114 is configured to transmit an alarm message 118 to a receiver 120 via radio transmitter 116. In some embodiments, monitor 108 itself includes radio transmitter 116. In some embodiments, alarm message 118 is a text message. In some embodiments, alarm message 118 is short message service (SMS). In some embodiments, alarm message 118 is multimedia message service (MMS). In some embodiments, alarm message 118 is a simple network paging protocol message. In some embodiments, alarm message 118 is configurable, for example by a location of the equipment apparatus, a location of the receiver, an identity of an individual owning the receiver, a nature of the alarm condition, a duration of the alarm condition, a severity of the alarm condition, an environmental condition at the equipment apparatus, and the like or combinations thereof. Thus, the system can be customized to provide alarm messages 118 that are deemed most helpful by a system 100 user.

In some embodiments, receiver 120 is a cellular phone or a satellite phone. In some embodiments, communication control module includes a SIM card (not pictured). In some embodiments, the SIM card holds the monitor's phone number and is effective to transmit and receive messages, as will be discussed in greater detail below. In some embodiments, receiver 120 includes a separate intermediate simple network paging protocol receiver or system server. In these embodiments, alarm message 118 is first sent to the intermediate receiver before being delivered to an individual's receiver, such as a cellular phone. In some embodiments, the intermediate receiver is owned and/or operated by a third-party service provider and facilitates delivery and tracking of alarm signals 106 and alarm messages 118. These embodiments enable better record keeping by routing alarm messages 118 through a central third-party hub.

In some embodiments, a housing (not pictured) encloses the control module, the monitor, and the communication control module. In some embodiments, equipment apparatus 102 is sold with system 100 preinstalled.

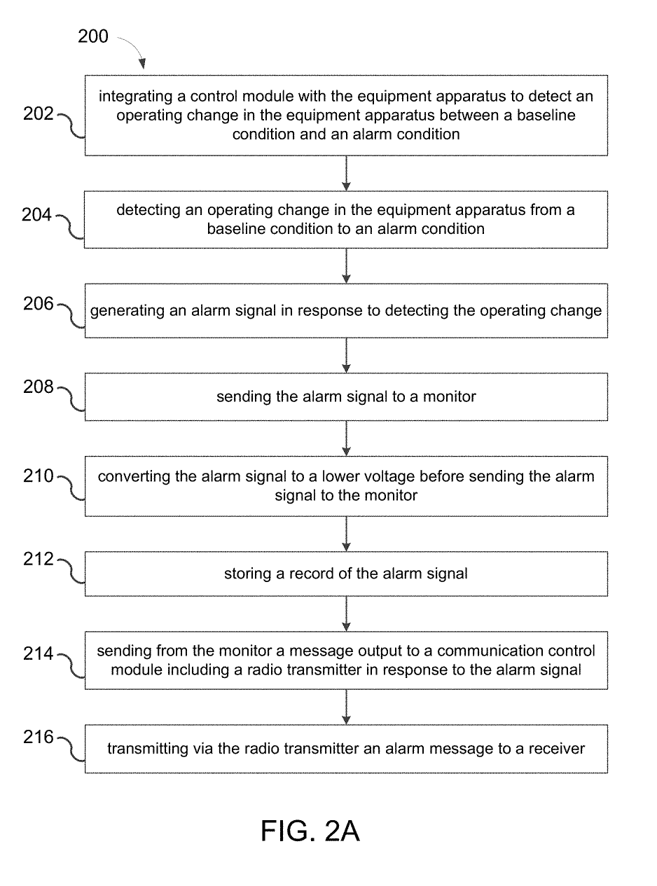

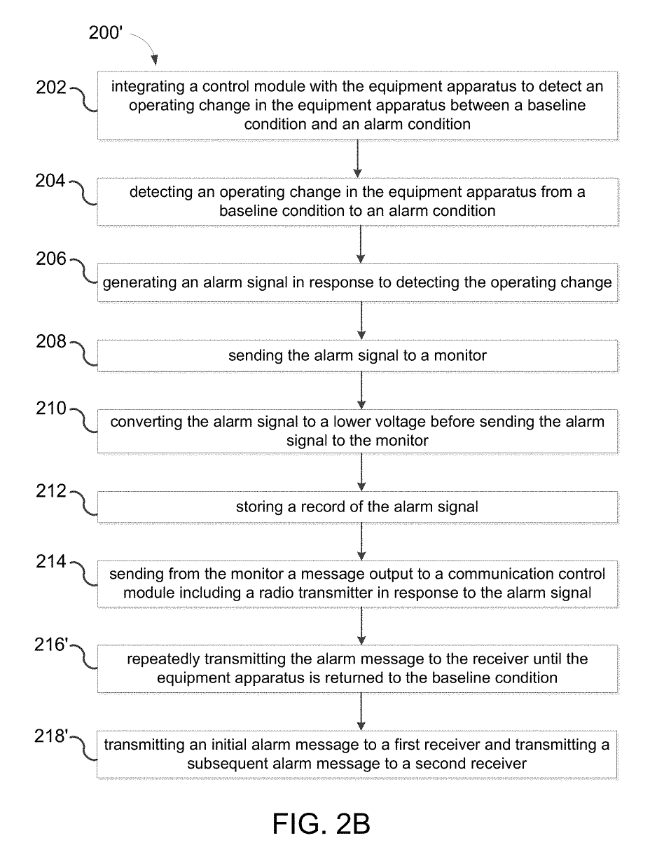

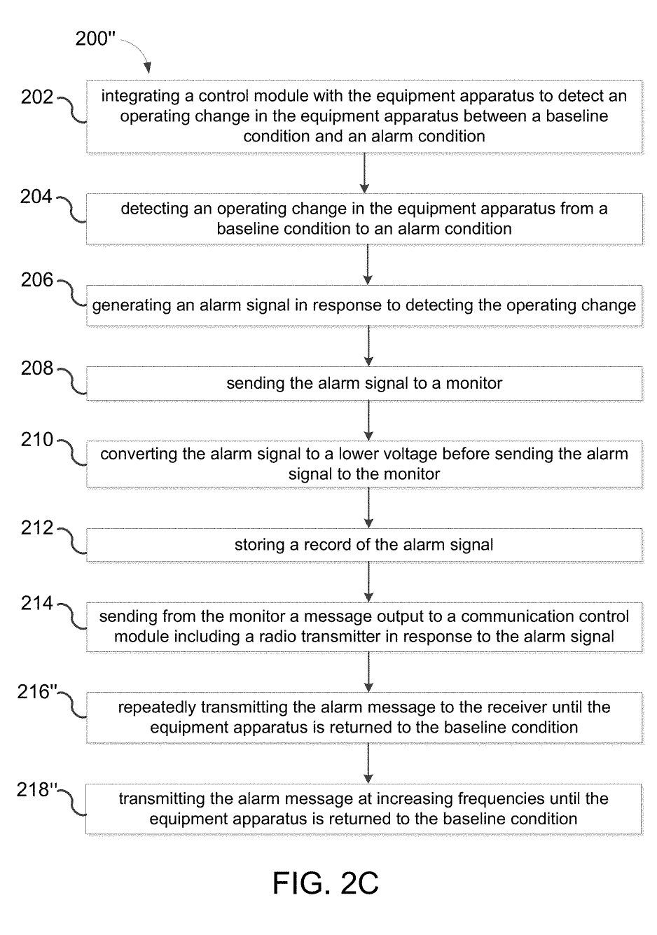

Referring now to FIG. 2A, some embodiments of the disclosed subject matter include a method 200 of monitoring an equipment apparatus. At 202, a control module is integrated with the equipment apparatus to detect an operating change in the equipment apparatus between a baseline condition and an alarm condition. At 204, an operating change from the baseline condition to the alarm condition is detected in the equipment apparatus. As discussed above, the operating changes detected in the equipment apparatus, the manner in which the control module is integrated into the equipment apparatus, and how the operating changes are detected are designed by one having ordinary skill in the art to identify alarm operating conditions deemed disadvantageous for a specific equipment apparatus or specific application of that equipment apparatus.

At 206, an alarm signal is generated in response to detecting the operating change. At 208, the alarm signal is sent to a monitor. As discussed above, in some embodiments, the alarm signal is an alarm voltage output. In some embodiments, at 210, the alarm signal is converted to a lower voltage.

In some embodiments, at 212, a record of the alarm signal is stored. In some embodiments, the records are sent to a monitoring service. In some embodiments, the records are stored on a local server. In some embodiments, records are stored on a remote server. In some embodiments, records are stored via a cloud service. Such embodiments allow for storage and later retrieval of monitoring and alert information, creating a historical record of the behavior and maintenance of an equipment apparatus. Should damages occur as a result of equipment apparatus failure or malfunction, this stored information can prove useful in the resolution of a dispute arising therefrom. In some embodiments, the monitoring service facilitates control and/or configuration changes and requests from system users. In some embodiments, the monitoring service sends messages to individuals alerting of control/configuration changes.

At 214, the monitor sends a message output to a communication control module in response to the alarm signal. As discussed above, in some embodiments, the message output is a message voltage output. Also as discussed above, in some embodiments, the communication control module includes a radio transmitter, e.g., a cellular radio transmitted or a satellite radio transmitter.

At 216, an alarm message is transmitted via a radio transmitter to a receiver. As discussed above, in some embodiments, the receiver is a cellular phone or a satellite phone. Referring now to FIG. 2B and method 200′, in some embodiments, at 216′, the alarm message is repeatedly transmitted to the receiver until the equipment apparatus is returned to the baseline condition. In some embodiments, returning the equipment apparatus to a baseline condition requires human intervention. In some embodiments, the alarm messages are sent at consistent intervals. At 218′, an initial alarm message is transmitted to a first receiver, while subsequent alarm messages are transmitted to at least one second receiver. Referring now to FIG. 2C and method 200″, in some embodiments, at 216″, the alarm message is repeatedly transmitted to the receiver until the equipment apparatus is returned to the baseline condition. At 218″, alarm messages are transmitted at increasing frequency until the equipment apparatus is returned to the baseline condition. In these embodiments, for example, if the baseline condition is not reestablished in at least 1 day, at least 12 hours, at least 6 hours, at least 1 hour, at least 30 minutes, at least 10 minutes, at least 1 minute, and the like, subsequent alarm messages are sent more and more frequently. In some embodiments, there is a threshold frequency at which alert messages are not sent with greater frequency, such as once per day, once per hour, once per minute, at the like. As discussed above, in some embodiments, the alarm messages are text messages, such as SMS messages or simple network paging protocol messages. In some embodiments, the messages are also sent to a monitoring service, local server, remote server, or cloud service for storage.

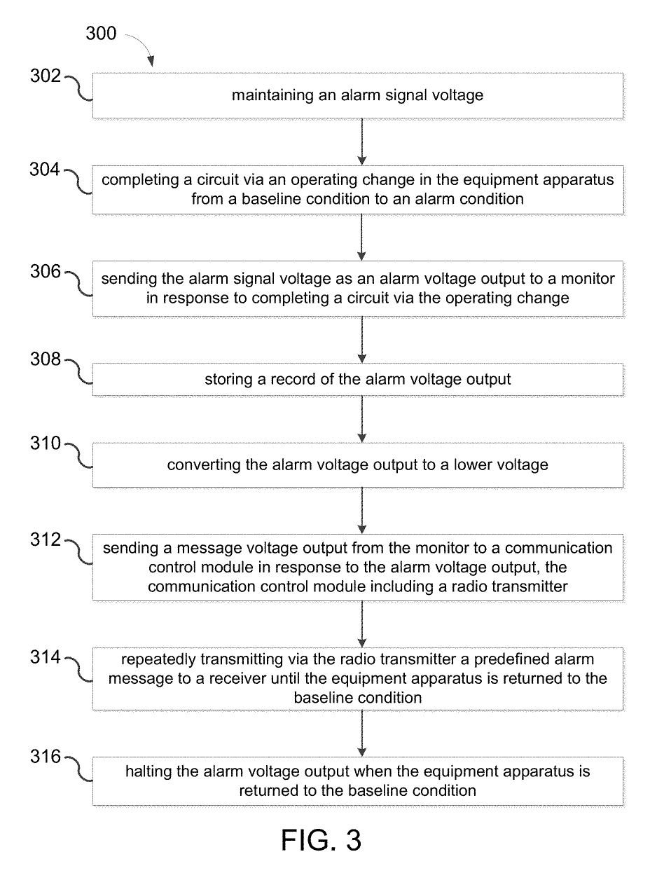

Referring now to FIG. 3, some embodiments of the disclosed subject matter include a method 300 of monitoring an equipment apparatus including, at 302, maintaining an alarm signal voltage. At 304, a circuit is completed via an operating change in the equipment apparatus from a baseline condition to an alarm condition. At 306, the alarm signal voltage is then sent as an alarm voltage output to a monitor in response to completing a circuit via the operating change. At 308, a record of the alarm voltage output is stored.

At 310, the alarm voltage output is converted to a lower voltage. At 312, a message voltage output is sent from the monitor to a communication control module in response to the alarm voltage output. As discussed above, the communication control module includes a radio transmitter. At 314, a predefined alarm message is repeatedly transmitted via the radio transmitter to a receiver until the equipment apparatus is returned to the baseline condition. As discussed above, in some embodiments, the predefined alarm message is configured based on a location of the equipment apparatus, a location of the receiver, an identity of an individual owning the receiver, a nature of the alarm condition, a duration of the alarm condition, a severity of the alarm condition, an environmental condition at the equipment apparatus, and the like or combinations thereof. At 316, the alarm voltage output is halted when the equipment apparatus is returned to the baseline condition.

As discussed above, in some embodiments, the content of the alarm message and the progression of the alarm message transmission are customizable. For example, in some embodiments, different alarm messages are sent for different operating changes, such as an environmental power failure, equipment apparatus power failure, control module power failure, ignition failure, equipment apparatus component malfunction, or fuel depletion, and the like. In some embodiments, the alarm message varies depending upon location of the equipment, location of the individual receiving the message, identity of the individual receiving the message, nature of the malfunction, duration of the alarm signal, duration of the alarm condition, severity of the alarm condition, environmental temperature, temperature of the equipment apparatus' location, and the like. In this way, a nearby lower-level technician may be first alerted, then a technician who is further away, and then a supervisor and then a building owner and so on the longer an alarm signal is allowed to remain active. In some embodiments, all individuals are sent a message alerting them when a baseline condition has been restored to an equipment apparatus.

By way of example, an unoccupied building runs out of fuel, and as a result the boiler/furnace fails to ignite. This operating change causes the control module to alarm. The preprogrammed message “The heating has failed in Building X, 123 Street, XYC City” is sent to the designated receptive cell phone number(s). As the designated recipients of the message, the management company and/or their technicians and/or building owner receive the identical message. By way of another example, in the event of a power failure, a battery backup system engages and a message “There is a power failure in Building X, 123 Street, XYC City” is being sent to the designated individuals. The same message is also sent to the monitoring and recording station/service to be stored for retrieval.

In some embodiments, the monitoring system is sold to a user as a one-time equipment fee for the system itself and monthly service fee for the monitoring and messaging services. The system is thus capable of operating as cellular or satellite communications system, where in some embodiments, wireless communication service providers and data storage providers lend support services through their infrastructure.

The systems and methods of the present disclosure enable remote monitoring of equipment apparatus while avoiding the high cost of internet and land-line based solutions. The system is integrated with the equipment apparatus, and is able to monitor its operation to determine when the equipment apparatus is malfunctioning. Cellular or satellite radio transmitters effectively deliver alarm messages to an individual's cellular or satellite telephone, and can do so in a customizable away. An external power supply even allows monitoring and transmission of alarm messages when power is lost. Troubleshooting and maintenance of equipment apparatus can thus be made more efficient, reducing the need for regular time-consuming diagnostic check-ups, and reducing recognition time of malfunctioning equipment apparatus. Installation is extremely simple, taking an HVAC technician less than 10 minutes. Additionally, the monitoring system of the present disclosure is low cost and provides recorded notifications to resolve any eventual disputes.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A method of monitoring an equipment apparatus comprising:
integrating a control module with said equipment apparatus to detect an operating change in said equipment apparatus between a baseline condition and an alarm condition;
detecting an operating change in said equipment apparatus from a baseline condition to an alarm condition;
generating an alarm signal in response to detecting said operating change;
sending said alarm signal to a monitor;
sending from said monitor a message output to a communication control module including a radio transmitter in response to said alarm signal; and
transmitting via said radio transmitter an alarm message to a receiver.

2. The method according to claim 1, further comprising converting said alarm signal to a lower voltage before sending said alarm signal to said monitor.

3. The method according to claim 1, wherein said receiver is a cellular phone or a satellite phone.

4. The method according to claim 1, wherein said radio transmitter is a cellular radio transmitter or a satellite radio transmitter.

5. The method according to claim 1, wherein said alarm message is a text message or simple network paging protocol message.

6. The method according to claim 1, wherein said operating change includes an environmental power failure, equipment apparatus power failure, control module power failure, an ignition failure, equipment apparatus component malfunction, or fuel depletion.

7. The method according to claim 1, further comprising:
repeatedly transmitting said alarm message to said receiver until said equipment apparatus is returned to said baseline condition; and
transmitting an initial alarm message to a first receiver and transmitting a subsequent alarm message to a second receiver.

8. The method according to claim 1, further comprising:
repeatedly transmitting said alarm message to said receiver until said equipment apparatus is returned to said baseline condition; and
transmitting said alarm message at increasing frequencies until said equipment apparatus is returned to said baseline condition.

9. The method according to claim 1, further comprising storing a record of said alarm signal.

10. A system for monitoring an equipment apparatus comprising:
a control module integrated with said equipment apparatus and positioned in said equipment apparatus to detect an operating change in said equipment apparatus between a baseline condition and an alarm condition;
an alarm voltage output generated and sent by said control module in response to said operating change from a baseline condition to an alarm condition;
a monitor positioned to receive said alarm voltage output from said control module and configured to send a message voltage output in response to said alarm voltage output;
a communication control module positioned to receive said message voltage output, said communication control module including a radio transmitter; and
a housing enclosing said control module, said monitor, and said communication control module;
wherein said operating change includes an environmental power failure, equipment apparatus power failure, control module power failure, ignition failure, equipment apparatus component malfunction, or fuel depletion, and said communication control module is configured to transmit an alarm message to a receiver via said radio transmitter.

11. The system according to claim 10, wherein said receiver is a cellular phone or a satellite phone.

12. The system according to claim 10, wherein said radio transmitter is a cellular radio transmitter or a satellite radio transmitter.

13. The system according to claim 10, wherein said alarm voltage output received by said monitor has a lower voltage than said alarm voltage output sent by said control module.

14. The system according to claim 13, wherein said alarm voltage output received by said monitor has a voltage of about +5V.

15. The system according to claim 10, wherein said alarm message is a text message or simple network paging protocol message.

16. The system according to claim 10, wherein said monitor includes an external power supply positioned to supply power to said monitor and convert said alarm voltage output to a lower voltage.

17. The system according to claim 16, wherein said external power supply is a battery, a generator, a fuel cell, or a combination thereof.

18. The system according to claim 10, further comprising a plurality of equipment apparatus, each equipment apparatus of said plurality of equipment apparatus including a monitor.

19. A method of monitoring an equipment apparatus comprising:
maintaining an alarm signal voltage;
completing a circuit via an operating change in said equipment apparatus from a baseline condition to an alarm condition;
sending said alarm signal voltage as an alarm voltage output to a monitor in response to completing a circuit via said operating change;
storing a record of said alarm voltage output;
converting said alarm voltage output to a lower voltage;
sending a message voltage output from said monitor to a communication control module in response to said alarm voltage output, said communication control module including a radio transmitter;
halting said alarm voltage output when said equipment apparatus is returned to said baseline condition; and
repeatedly transmitting via said radio transmitter a predefined alarm message to a receiver until said equipment apparatus is returned to said baseline condition.

20. The method according to claim 19, said predefined alarm message is configured based on a location of said equipment apparatus, a location of said receiver, an identity of an individual owning said receiver, a nature of said alarm condition, a duration of said alarm condition, a severity of said alarm condition, an environmental condition at said equipment apparatus, or combinations thereof.
